(19) United States
(12) Patent Application Publication
(10) Pub. No.: US 2007/0143544 A1
(43) Pub. Date: Jun. 21, 2007

(54) Low profile card reading device

(75) Inventors: Kun-Cheng Lin, Chung Ho City (TW); Wen-Lung Lin, Chung Ho City (TW); Yi-Ling Liu, Chung Ho City (TW); Chang-Cheng Tsai, Chung Ho City (TW)

Correspondence Address: TROXELL LAW OFFICE PLLC;ONE SKYLINE PLACE, SUITE 1404, 5205 LEESBURG PIKE, FALLS CHURCH, VA, 22041, US

(73) Assignee: Power Quotient International Co., Ltd.

(21) Appl. No.: 11/640,245

(22) Filed: Dec. 18, 2006

(30) Foreign Application Priority Data
Dec. 20, 2005 (TW) 094145202

(51) Int. Cl. G06F 12/00

(52) U.S. Cl. 711/115

(57) ABSTRACT

A low profile card reading device is disclosed to include a first interface having a plurality of contact terminals movably exposed to the outside for connection to a computer, an interface controller coupled to the first interface to execute signal conversion and protocol operation of the first interface, a memory card slot for the insertion of a memory card, a card reading device controller respectively coupled to the interface controller and the memory card slot to transfer data from the memory card in the memory card slot to the computer and to store data from the computer to the memory card in the memory card slot.

### BACKGROUND OF THE INVENTION

1. Field of the Invention

The present invention relates to card reading device and more particularly, to a low profile card reading device, which has the shape and thickness of a credit card.

2. Description of the Related Art

Regular card reading device for commercial flash memory cards commonly provide only one memory card slot for a specific memory card. However, due to the effect of the thickness of the interface connector or the connection of the cable between the interface connector and the card reading device, the conventional card reading device are inconvenient to carry by the user and do not have a thinnerization characteristic.

The Netherlands Patent No. NL1022277C (filed on Dec. 30, 2002, issued on Jul. 1, 2004) discloses a memory card slot device that comprises a housing, a printed circuit board, a USB controller, a memory card slot chip, a USB connector, and a cable. This patent is adapted to provide a flat type card reading device. However, this patent has a certain thickness because of the use of a regular USB connector. Further, this patent uses a cable to connect the USB connector to the USB controller. The use of the cable results in carrying inconvenience.

Therefore, it is desirable to provide a low profile card reading device that has a shape and size approximately equal to a credit card.

### SUMMARY OF THE INVENTION

The present invention has been accomplished under the circumstances in view. It is the main object of the present invention to provide a low profile card reading device, which uses a low thickness interface connector to lower the thickness of the low profile card reading device.

It is another object of the present invention to provide a low profile card reading device, which has a low thickness interface connector directly coupled to the interface controller thereof by a circuit line without through a cable so that the low profile card reading device is convenient for carriage by the user.

It is still another object of the present invention to provide a low profile card reading device, which has a second interface connector connectable to a mobile electronic apparatus so that the low profile card reading device can be used as a memory card.

It is still another object of the present invention to provide a low profile card reading device, which has a memory card slot for receiving a memory card so that the low profile card reading device can be used as a card reading device.

To achieve these and other objects of the present invention, the low profile card reading device comprises a housing that houses parts of the low profile card reading device, a first interface, which has a plurality of contact terminals movably extending out of the housing for connection to a computer, an interface controller coupled to the first interface and adapted to execute signal conversion and protocol operation of the first interface, a memory card slot for receiving a memory card, a card reading device controller respectively coupled to the interface controller and the memory card slot and adapted to transfer data from the memory card in the memory card slot to the computer and to store data from the computer in the memory card in the memory card slot.

The first interface can be an I-Stick interface compatible to a USB interface.

The low profile card reading device further comprises a printed circuit board carrying the interface controller, the memory card slot and the card reading device controller. The printed circuit board has circuit line means coupled to the first interface.

The printed circuit board can be a flexible printed circuit board, and the circuit line means can be directly formed on the flexible printed circuit board.

The low profile card reading device further comprises a second interface, a second interface controller, and a memory. The second interface and the memory are respectively coupled to the second interface controller. The second interface has a plurality of contact terminals extending out of the housing for connection to an external electronic device, which can be a personal digital assistant, digital camera, or mobile video player.

The second interface can be a SmartMedia, CompactFlash, MMC, Security Digital (SD), Memory Stick, Memory Stick Pro, xD or Microdrive, Memory Stick Duo or Memory Stick Pro Duo memory card interfaces

The low profile card reading device further comprises a display device and a drive circuit. The display device is coupled to the card reading device controller for displaying information. The drive circuit is coupled to the display device.

The display device can be STN-LCD (Super Twisted Nematic LCD), TFT LCD (Thin Film Transistor LCD), or OLED (Organic Light Emitting Display).

The low profile card reading device further comprises a receiver coupled to the card reading device controller to receive external information wirelessly. The receiver can be a bluetooth module or wireless network module.

The low profile card reading device further comprises a solar charger provided outside the housing and coupled to the interface controller, the memory card slot and the card reading device controller, and adapted to receive the radiation energy of the sun and to convert the radiation energy of the sun into electric energy for use by the interface controller, the memory card slot and the card reading device controller.

The solar charger comprises a solar panel and a storage battery. The solar panel receives the radiation energy of the sun, and converts the radiation energy of the sun into electric energy. The storage battery is adapted to store electric energy from the solar panel.

The low profile card reading device further comprises a magnetic strip provided outside the housing for recording usage track of the low profile card reading device.

Further, the low profile card reading device has a card-like outer appearance. The card-like outer appearance has a size equal to a credit card.

Further, the housing is comprised of a top cover shell and a bottom cover shell. The top cover shell and the bottom cover shell are fastened together to house the first interface, the interface controller, the memory card slot and the card reading device controller.

### BRIEF DESCRIPTION OF THE DRAWINGS

FIG. 1 is a schematic exploded view of a low profile card reading device according to the present invention.

FIG. 2 illustrates the low profile card reading device assembled for use in a computer.

FIG. 3 is a schematic drawing of the present invention, showing the low profile card reading device further provided with a second interface, a second interface controller and a memory.

FIG. 4 is a schematic drawing of the present invention showing the low provide card reading device further provided with a display device and a drive circuit.

FIG. 5 is a schematic drawing of the present invention showing the low provide card reading device further provided with a receiver.

FIG. 6 is a schematic drawing of the present invention showing the low provide card reading device further provided with a solar charger.

FIG. 7 is a schematic drawing of the present invention showing the low provide card reading device further provided with a magnetic strip.

### DETAILED DESCRIPTION OF THE PREFERRED EMBODIMENT

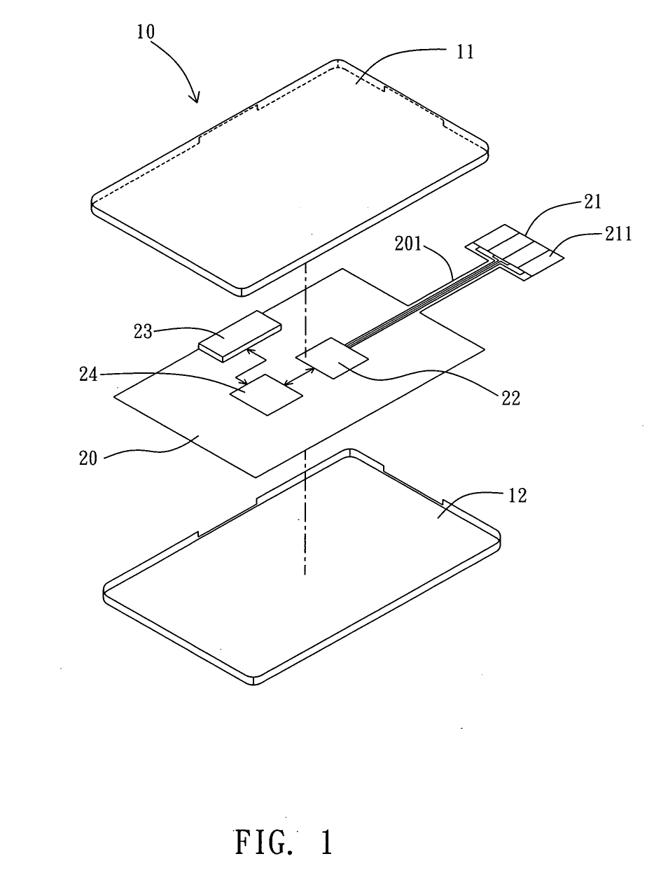

Referring to FIG. 1, a low profile card reading device 1 in accordance with the present invention is shown comprised of a housing 10, a printed circuit board 20, a first interface 21, an interface controller 22, a memory card slot 23, and a card reading device controller 24.

The housing 10 is comprised of a flat top cover shell 11 and a flat bottom cover shell 12, holding the first interface 21, the interface controller 22, the memory card slot 23 and the card reading device controller 24 on the inside. Alternatively, the housing 10 can be made in integrity. The housing 10 has a flat outer appearance shaped like a flat card approximately equal to the standard size of a credit card.

The printed circuit board 20 is adapted to carry the interface controller 22, the memory card slot 23 and the card reading device controller 24, having a circuit line 201 coupled to the first interface 21. The printed circuit board 20 can be a flex circuit board that minimizes the thickness of the card reading device 1. The circuit line 201 is movable. Further, the circuit line 201 can be directly formed on the printed circuit board 20.

The first interface 21 is an I-Stick interface, having a low profile and compatible to a regular USB interface. The first interface 21 has a plurality of contact terminals 211 movably extended from one side of the printed circuit board 20 for coupling to one USB port of the computer 50.

The interface controller 22 is a USB interface controller. By means of the wiring of lead wires (not shown) on the printed circuit board 20 and coupling of the circuit line 201 to the first interface 21, the interface controller 22 executes signal conversion and protocol operation of the first interface 21. Therefore, the invention uses a low thickness and non-standard interface that is useable in the interface of a USB connector, for example, an I-Stick interface from Power Quotient International, Taiwan. The use of an I-Stick interface can reduce the thickness of the interface connector. Further, by means of the wiring of lead wires on the printed circuit board 20 and the coupling of the circuit line 201 to the first interface 21, the invention eliminates the use of a cable so that the low profile card reading device 1 is convenient to carry by the user.

The memory card slot 23 is for the insertion of a memory card that can be a SmartMedia, CompactFlash, MMC, Security Digital (SD), Memory Stick, Memory Stick Pro, xD or Microdrive, Memory Stick Duo or Memory Stick Pro Duo memory card.

The card reading device controller 24 is respectively coupled to the interface controller 22 and the memory card slot 23 for receiving data from the memory card that is inserted into the memory card slot 23 and transmitting the data to the computer 50, and for receiving data from the computer 50 and storing the data in the memory card that is inserted into the memory card slot 23.

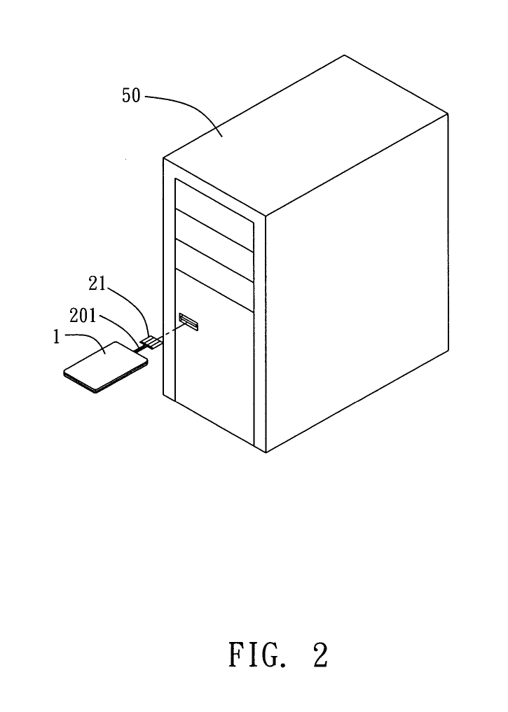

Referring to FIG. 2 again, during the assembly process of the low profile card reading device 1, the circuit line 201 is arranged on the printed circuit board 20 properly, and then the first interface 21, the interface controller 22, the memory card slot 23 and the card reading device controller 24 are arranged on the printed circuit board 20, and then the printed circuit board 20 with the interface controller 22, the memory card slot 23 and the card reading device controller 24 are housed inside the housing 10, allowing the first interface 21 to be suspending outside the housing 10. After the low profile card reading device 1 is assembled, the first interface 21 is inserted into one USB port of the computer 50 so that the computer 50 can fetch data from the memory card (not shown) in the memory card slot 23 or store data in the memory card in the memory card slot 23. As stated above, the invention uses an I-Stick interface for the first interface 21 to reduce the thickness of the interface connector. By means of the layout of lead wires on the printed circuit board 20 and coupling of the circuit line 201 to the first interface 21 to substitute for a cable, the low profile card reading device 1 is convenient to carry by the user.

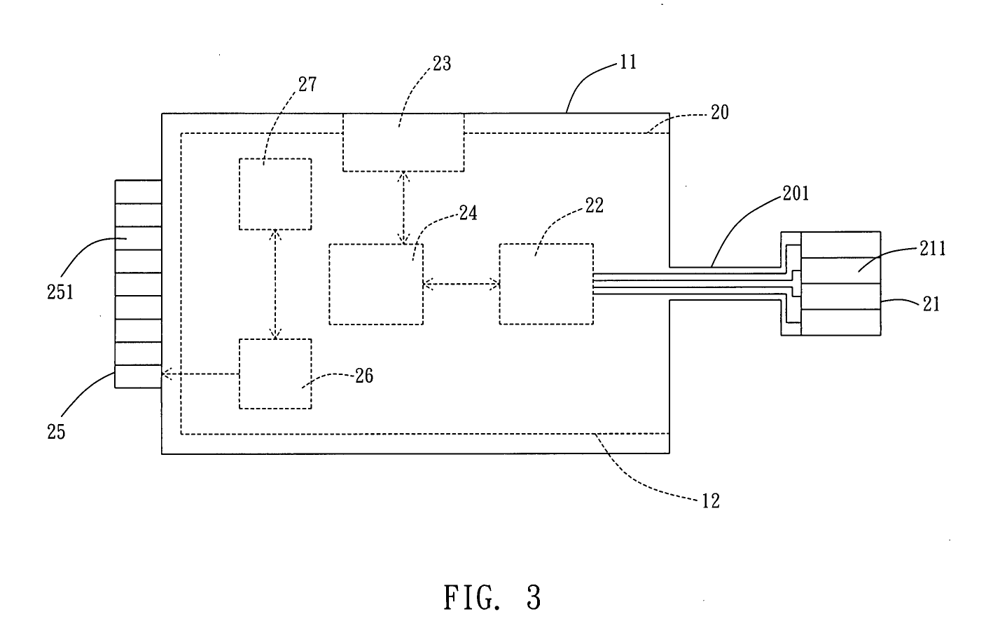

Referring to FIG. 3, the low profile card reading device 1 further comprises a second interface 25, a second interface controller 26, and a memory 27. The second interface 25 and the memory 27 are respectively coupled to the second interface controller 26. Further, the second interface 25 has its contact terminals 251 suspending outside the housing 10 for insertion into an electronic device, for example, a PDA, digital camera, or mobile video player. The second interface 25 can be a SmartMedia, CompactFlash, MMC, Security Digital (SD), Memory Stick, Memory Stick Pro, xD or Microdrive, Memory Stick Duo or Memory Stick Pro Duo memory card interface.

The second interface controller 26 is adapted to control the second interface 25, enabling the low profile card reading device 1 to be used as a SmartMedia, CompactFlash, MMC, Security Digital (SD), Memory Stick, Memory Stick Pro, xD or Microdrive, Memory Stick Duo or Memory Stick Pro Duo memory card slot card.

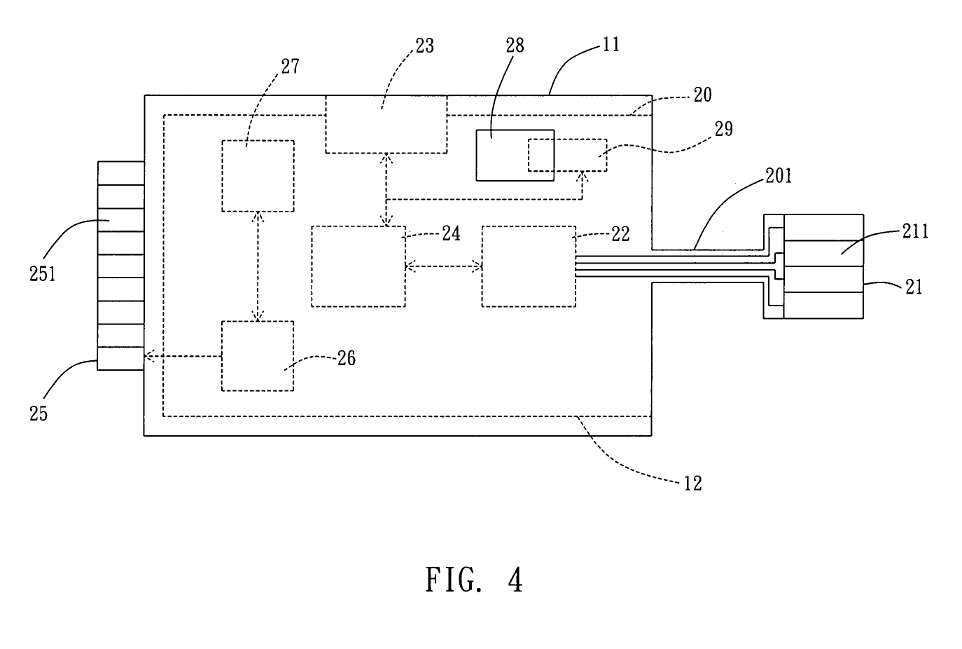

Referring to FIG. 4, the low profile card reading device 1 further comprises a display device 28 and a drive circuit 29. The display device 28 is arranged on the outside of the housing 10 for displaying related message, having a circuit line (not shown) coupled to the card reading device controller 24. The drive circuit 29 is coupled to the display device 28, and adapted to drive the display device 28. The display device 28 can be, for example, a STN-LCD (Super Twisted Nematic LCD), TFT LCD (Thin Film Transistor LCD), OLED (Organic Light Emitting Display).

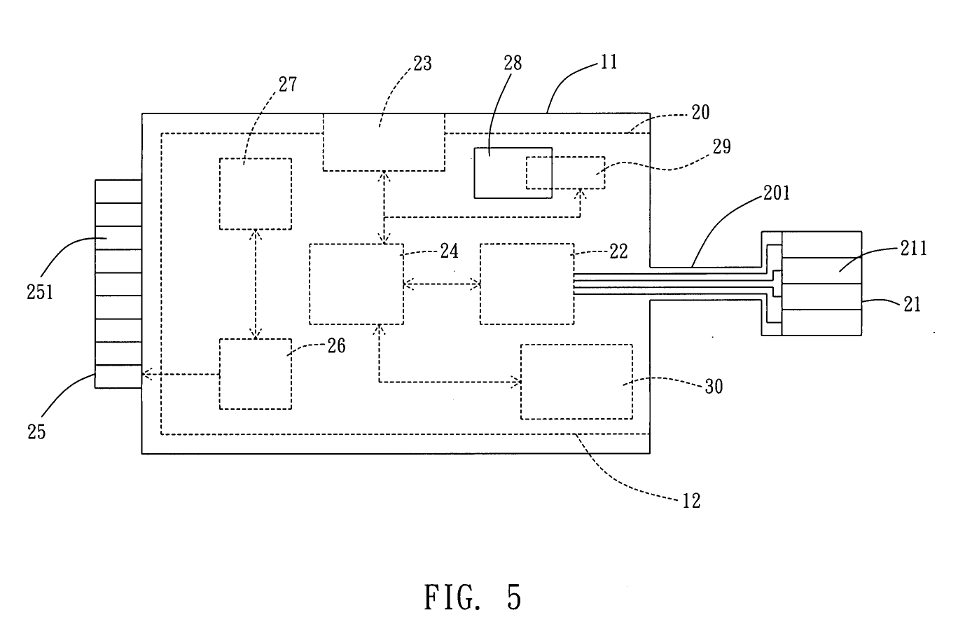

Referring to FIG. 5, the low profile card reading device 1 further comprises a receiver 30. The receiver 30 can be a bluetooth module or wireless network module. It is coupled to the card reading device controller 24 so that the low profile card reading device 1 can receive external information wirelessly.

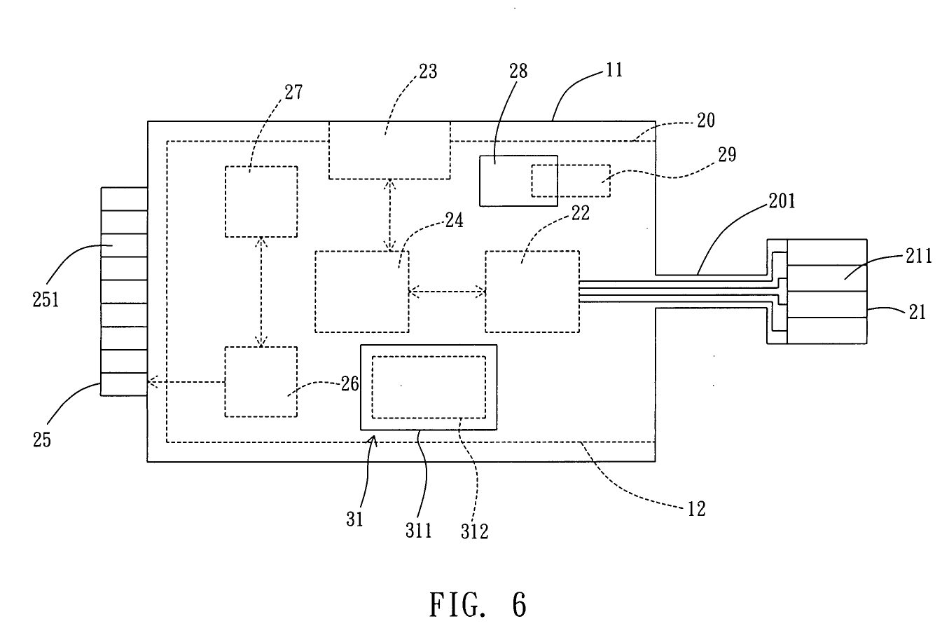

Referring to FIG. 6, the low profile card reading device 1 further comprises a solar charger 31. The solar charger 31 is provided on the outside of the housing 10, having circuit lines respectively coupled to the interface controller 22, the memory card slot 23, the card reading device controller 24, the second interface 25, the second interface controller 26, the memory 27, the display device 28, the drive circuit 29, and the receiver 30. The solar charger 31 receives the radiation energy of the sun and converts it into electric energy for the devices connected thereto.

The solar charger 31 comprises a solar panel 311 and a storage battery 312. The solar panel 311 is mounted on the outside of the housing 10, and adapted to receive the radiation energy of the sun and converts the received sunlight energy into electric energy for storing in the storage battery 312.

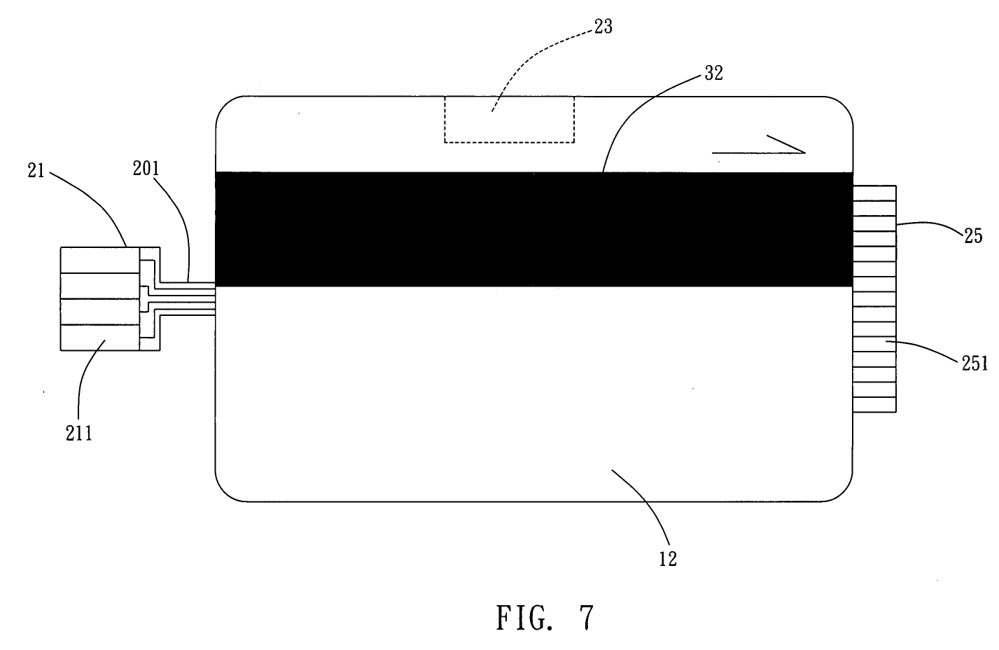

Referring to FIG. 7, the low profile card reading device 1 further comprises a magnetic strip 32. The magnetic strip 32 is arranged on the outside of the housing 10 for recording usage track of the low profile card reading device.

As stated above, the invention uses an I-Stick interface to reduce the thickness of the interface connector, and by means of the layout of lead wires on the printed circuit board and coupling of the circuit line to the USB interface to substitute for a cable, the low profile card reading device is convenient to carry by the user and eliminates the drawbacks of the prior design.

A prototype of low profile card reading device has been constructed with the features of FIGS. 1˜7. The low profile card reading device functions smoothly to provide all of the features as discussed before.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A low profile card reading device comprising:
a housing that houses parts of the low profile card reading device;
a first interface, said first interface having a plurality of contact terminals movably extending out of said housing for connection to a computer;
an interface controller coupled to said first interface and adapted to execute signal conversion and protocol operation of said first interface;
a memory card slot for receiving a memory card;
a card reading device controller respectively coupled to said interface controller and said memory card slot and adapted to transfer data from the memory card that is inserted in said memory card slot to the computer and to store data from the computer in the memory card that is inserted in said memory card slot.

2. The low profile card reading device as claimed in claim 1, wherein said first interface is an I-Stick interface compatible to a USB interface.

3. The low profile card reading device as claimed in claim 2, further comprising a printed circuit board carrying said interface controller, said memory card slot and said card reading device controller, said printed circuit board having circuit line means coupled to said first interface, said printed circuit board being a flexible printed circuit board, said circuit line means being directly formed on said flexible printed circuit board.

4. The low profile card reading device as claimed in claim 3, further comprising a second interface, a second interface controller, and a memory, said second interface and said memory being respectively coupled to said second interface controller, said second interface having a plurality of contact terminals extending out of said housing for connection to an external electronic device, which is one of the devices including personal digital assistant, digital camera and mobile video player, said second interface is one of SmartMedia, CompactFlash, MMC, Security Digital (SD), Memory Stick, Memory Stick Pro, xD or Microdrive, Memory Stick Duo or Memory Stick Pro Duo memory card interfaces.

5. The low profile card reading device as claimed in claim 1, further comprising a display device and a drive circuit, said display device being coupled to said card reading device controller for displaying information, said drive circuit being coupled to said display device, said display device being one of STN-LCD (Super Twisted Nematic LCD), TFT LCD (Thin Film Transistor LCD), and OLED (Organic Light Emitting Display).

6. The low profile card reading device as claimed in claim 1, further comprising a receiver coupled to said card reading device controller to receive external information wirelessly, said receiver being selected from bluetooth module and wireless network module.

7. The low profile card reading device as claimed in claim 1, further comprising a solar charger provided outside said housing and coupled to said interface controller, said memory card slot and said card reading device controller, and adapted to receive the radiation energy of the sun and to convert the radiation energy of the sun into electric energy for use by said interface controller, said memory card slot and said card reading device controller.

8. The low profile card reading device as claimed in claim 7, wherein said solar charger comprises a solar panel and a storage battery, said solar panel receiving the radiation energy of the sun and converting the radiation energy of the sun into electric energy, said storage battery being adapted to store electric energy from said solar panel.

9. The low profile card reading device as claimed in claim 1, further comprising a magnetic strip provided outside said housing for recording usage track of the low profile card reading device.

10. The low profile card reading device as claimed in claim 1, which has a card-like outer appearance, said card-like outer appearance having a size equal to a credit card.

11. The low profile card reading device as claimed in claim 4, which has a card-like outer appearance, said card-like outer appearance having a size equal to a credit card.

12. The low profile card reading device as claimed in claim 1, wherein said housing is comprised of a top cover shell and a bottom cover shell, said top cover shell and said bottom cover shell being fastened together to house said first interface, said interface controller, said memory card slot and said card reading device controller.
